(19) United States
(12) Patent Application Publication
(10) Pub. No.: US 2017/0324182 A1
(43) Pub. Date: Nov. 9, 2017

(54) CONNECTOR

(71) Applicant: FUJITSU COMPONENT LIMITED, Tokyo (JP)

(72) Inventors: Koichi KIRYU, Nagano (JP); Mitsuru KOBAYASHI, Tokyo (JP); Takahiro KONDO, Tokyo (JP)

(21) Appl. No.: 15/527,418

(22) PCT Filed: Nov. 25, 2015
(86) PCT No.: PCT/JP2015/083019

§ 371 Date: May 17, 2017

(30) Foreign Application Priority Data
Nov. 28, 2014 (JP) 2014-241694

(51) Int. Cl. H01R 13/11; H01R 13/115; H01R 24/58; H01R 105/00

(52) U.S. Cl. CPC H01R 13/113; H01R 24/58; H01R 13/115; H01R 2105/00

(57) ABSTRACT

A connector configured to mate with and electrically connect to another connector includes a first contact configured to contact the other connector at a first position, and a second contact having a higher resistance value than the first contact, and configured to contact the other connector at a second position that is closer to the leading end of the connector than is the first position.

### TECHNICAL FIELD

The present invention relates to connectors.

### BACKGROUND ART

In general, electrical apparatuses are supplied with electric power from a power supply to operate. Normally, electric power is supplied from a power supply to an electrical apparatus via a connector. The connector used in this case establishes an electrical connection by mating a male-ended connector having a protruding shape and a female-ended connector having an indented shape.

In recent years, as a measure against global warming, the supply of direct-current high-voltage electric power, which is limited in power loss in voltage conversion or power transmission and does not require an increase in cable thickness, has been studied in power transmission in local areas as well. Such form of supplying electric power is considered desirable particularly for information apparatuses such as servers, which consume a large amount of electric power.

Electric power supplied to electrical apparatuses may affect human bodies or the operations of electronic components if the voltage is high. In the case of using such high-voltage electric power for information apparatuses such as servers, because the apparatuses are installed or maintained by human work, connectors that establish electrical connection need to be different from connectors used for a common alternate-current commercial power supply.

### PRIOR ART DOCUMENT

### [Patent Document 1] Japanese Examined Utility Model Publication No. 6-41350

### SUMMARY OF THE INVENTION

### Problems to be Solved by the Invention

When the voltage supplied from a power supply is 100 V or higher, or a direct-current high voltage, for example, when the electric power supplied from a power supply is direct-current 400 V, it is dangerous to use connectors presently used for alternating-current 100V as they are because sufficient safety and reliability are not ensured.

The present invention is made in view of the above, and has an object of providing a connector that makes it possible to supply high-voltage electric power with safety.

### Means for Solving the Problems

According to an aspect of the present invention, a connector configured to mate with and electrically connect to another connector includes a first contact configured to contact the other connector at a first position, and a second contact having a higher resistance value than the first contact, and configured to contact the other connector at a second position that is closer to the leading end of the connector than is the first position.

According to an aspect of the present invention, a connector configured to electrically connect to another connector includes a first metal plate configured to contact the other connector, a second metal plate configured to contact the other connector, and a resistor connected to the first metal plate and the second metal plate.

According to an aspect of the present invention, a connector configured to mate with and electrically connect to another connector includes a contact including multiple metal plates configured to contact the other connector and a resistor connecting adjacent metal plates among the multiple metal plates.

### Effects of the Invention

According to an aspect of the present invention, it is possible to provide a connector that is compatible with power supplies higher in voltage than presently-available commercial power supplies or with direct-current power supplies and makes it possible to safely supply electric power from these power supplies.

### BRIEF DESCRIPTION OF THE DRAWINGS

FIG. 1 is a perspective view of a jack contact according to a first embodiment.

FIG. 2 is a side view of the jack contact according to the first embodiment.

FIG. 3 is a perspective view of a plug contact according to the first embodiment.

FIG. 4 is a side view of the plug contact according to the first embodiment.

FIG. 5 is a diagram illustrating a connector according to the first embodiment.

FIG. 6A is a diagram illustrating the case of pulling out the plug contact from the jack contact according to the first embodiment.

FIG. 6B is a diagram illustrating the case of pulling out the plug contact from the jack contact, according to the first embodiment.

FIG. 6C is a diagram illustrating the case of pulling out the plug contact from the jack contact according to the first embodiment.

FIG. 6D is a diagram illustrating the case of pulling out the plug contact from the jack contact according to the first embodiment.

FIG. 7 is a perspective view of a jack contact and a plug contact according to a second embodiment.

FIG. 8 is a plan view of the jack contact and the plug contact according to the second embodiment.

FIG. 9 is a side view of the jack contact and the plug contact according to the second embodiment.

FIG. 10 is a diagram illustrating the plug contact according to the second embodiment.

FIG. 11 is a diagram illustrating a connector according to the second embodiment.

FIG. 12A is a diagram illustrating the case of pulling out the plug contact from the jack contact according to the second embodiment.

FIG. 12B is a diagram illustrating the case of pulling out the plug contact from the jack contact according to the second embodiment.

FIG. 13A is a diagram illustrating the case of pulling out the plug contact from the jack contact according to the second embodiment.

FIG. 13B is a diagram illustrating the case of pulling out the plug contact from the jack contact according to the second embodiment.

FIG. 14A is a diagram illustrating the case of pulling out the plug contact from the jack contact according to the second embodiment.

FIG. 14B is a diagram illustrating the case of pulling out the plug contact from the jack contact according to the second embodiment.

FIG. 15A is a diagram illustrating the case of pulling out the plug contact from the jack contact according to the second embodiment.

FIG. 15B is a diagram illustrating the case of pulling out the plug contact from the jack contact according to the second embodiment.

FIG. 16A is a diagram illustrating the case of pulling out the plug contact from the jack contact according to the second embodiment.

FIG. 16B is a diagram illustrating the case of pulling out the plug contact from the jack contact according to the second embodiment.

### EMBODIMENTS OF THE INVENTION

Embodiments of the present invention are described below. The same members or the like are assigned the same reference numeral, and are not repetitively described.

### First Embodiment

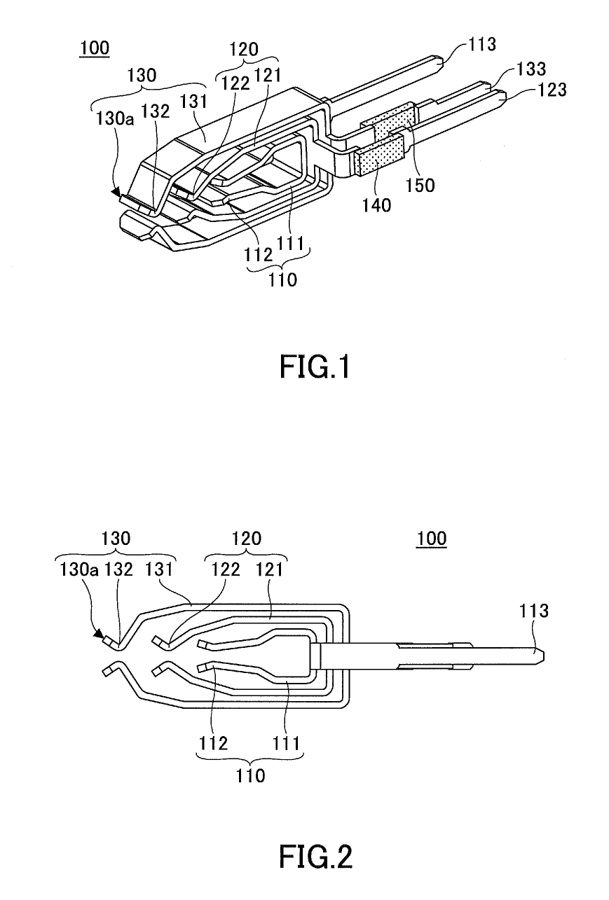

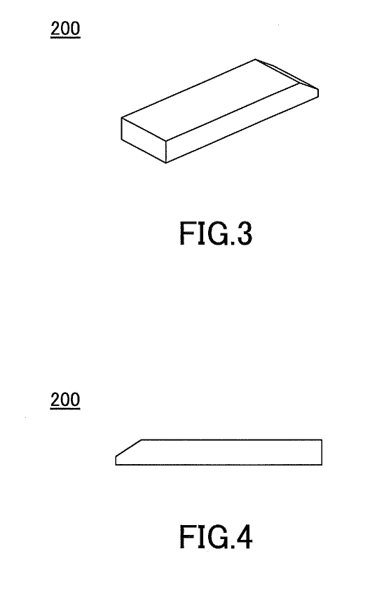

A connector according to a first embodiment is described. FIGS. 1 and 2 are a perspective view and a side view, respectively, of a jack contact 100 according to this embodiment. FIGS. 3 and 4 are a perspective view and a side view, respectively, of a plug contact 200 according to this embodiment.

The connector according to this embodiment is the jack contact 100 as depicted in FIGS. 1 and 2 or a jack connector that includes the jack contact 100. The connector according to this embodiment mates with and electrically connects to another connector. The other connector is the plate-shaped plug contact 200 as depicted in FIGS. 3 and 4 or a plug connector including the plug contact 200. In the following description, the connector according to this embodiment may be referred to as “jack connector”, and the other connector according to this embodiment may be referred to as “plug connector.”

The jack contact 100 is surrounded and covered by a housing formed of an insulator such as a resin material, and an opening is formed in part of the housing where the plug contact 200 fits into the jack contact 100. The jack contact 100 is connected to a power supply cable.

The plug contact 200 is formed of a metal material such as copper into a plate shape. The plug connector may include a housing that is formed of an insulator and exposes the plug contact 200. The plug connector is connected to an electronic apparatus or the like.

According to this embodiment, one of the jack contact 100 and the plug contact 200 is connected to a power supply, and the other is connected to an electronic apparatus or the like.

As depicted in FIGS. 1 and 2, the jack contact 100 according to this embodiment includes a first jack 110, a second jack 120, and a third jack 130.

The first jack 110 is formed of a metal material such as copper. The first jack 110 includes a first jack contact 111 formed into a U shape, into which the plug contact 200 is inserted. The first jack contact 111 includes a first contact portion 112 that comes into contact with the plug contact 200 in the vicinity of its end. The first jack contact 111 is connected to a first jack terminal 113. The first jack terminal 113 is at the same potential as a second jack terminal 123 and a third jack terminal 133.

The second jack 120 is formed of a metal material such as copper. The second jack 120 includes a second jack contact 121 formed into a U shape, into which the plug contact 200 is inserted. The second jack contact 121 includes a second contact portion 122 that comes into contact with the plug contact 200 in the vicinity of its end. The second jack contact 121 is formed to surround the first jack contact 111. The second contact portion 122 is positioned outside the first jack contact 111. A first resistor 140 is provided between the second jack contact 121 and the second jack terminal 123.

The third jack 130 is formed of a metal material such as copper. The third jack 130 includes a third jack contact 131 formed into a U shape, into which the plug contact 200 is inserted. The third jack contact 131 includes a third contact portion 132 that comes into contact with the plug contact 200 in the vicinity of an end 130a. According to this embodiment, the third contact portion 132, the second contact portion 122, and the first contact portion 112 are arranged in this order of proximity to the plug contact 200. The third contact portion 132 is positioned at the end of the jack contact 100 in the fitting direction of the jack contact 100. The third jack contact 131 is formed to surround and cover the second jack contact 121. The third contact portion 132 is positioned outside the second jack contact 121. A second resistor 150 is provided between the third jack contact 131 and the third jack terminal 133.

According to this embodiment, the resistance value of the second resistor 150 is higher than the resistance value of the first resistor 140. For example, when the supply voltage is 400 V, no arc is believed to be generated if a flowing electric current is 1 A or less. Therefore, the resistance value of the second resistor 150 is preferably 400Ω or more.

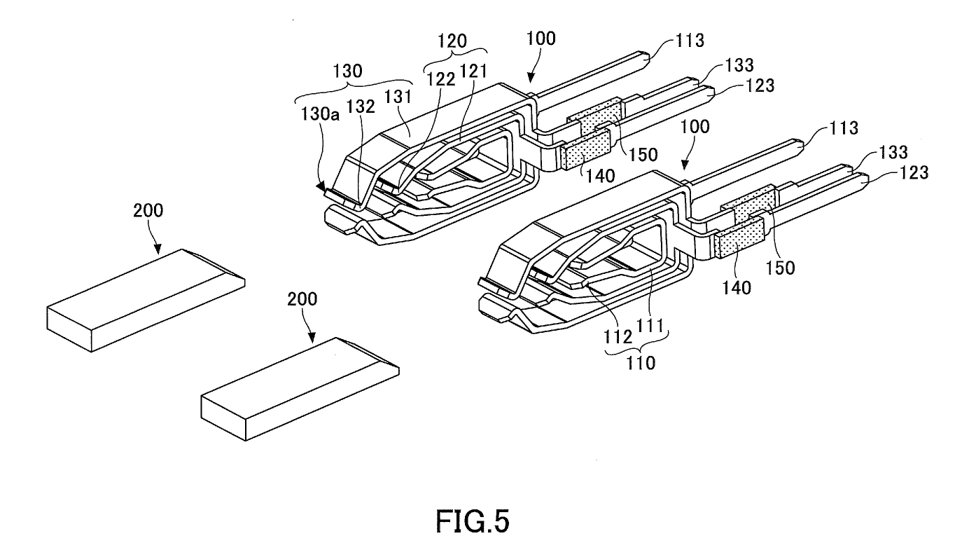

According to the connector of this embodiment, two jack contacts 100, one positive and one negative, are provided as depicted in FIG. 5. Likewise, two plug contacts 200, one positive and one negative, are provided to electrically connect to the jack contacts 100.

Next, removal of the plug connector from the jack connector according to this embodiment is described. According to this embodiment, it is assumed that the first jack terminal 113, the second jack terminal 123, and the third jack terminal 133 are interconnected and are further connected to a high-voltage power supply such as a direct-current power supply of +400 V.

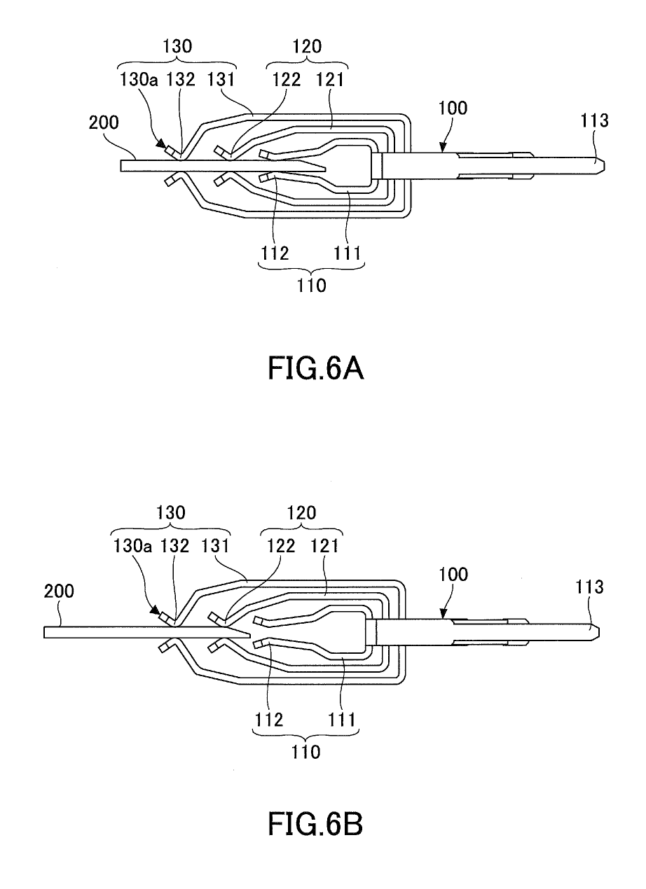

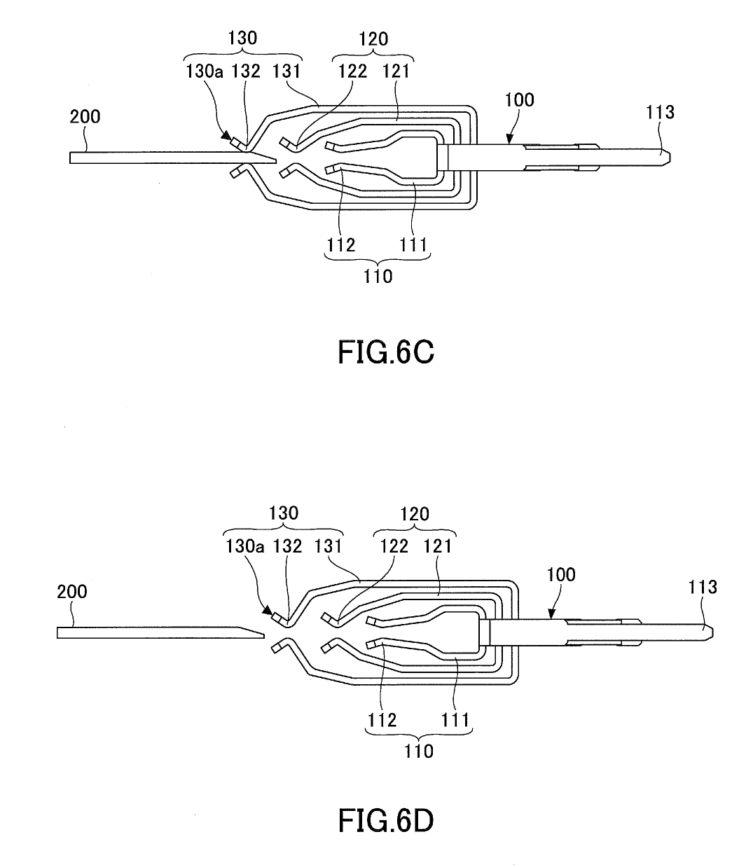

FIG. 6A depicts the jack contact 100 and the plug contact 200 of this embodiment, fitted to each other to supply electric power through the jack contact 100 and the plug contact 200. In the state of FIG. 6A, the plug contact 200 contacts each of the first contact portion 112, the second contact portion 122, and the third contact portion 132.

As described above, the first resistor 140 is provided between the second jack contact 121 and the second jack terminal 123, and the second resistor 150 is provided between the third jack contact 131 and the third jack terminal 133. No resistor, however, is provided between the first jack contact 111 and the first jack terminal 113. Accordingly, the electric current flowing from the jack contact 100 to the plug contact 200 flows most through a current path of the lowest resistance that goes through the first jack 110. That is, most of the electric current flows from the first jack terminal 113 to the plug contact 200 through the first jack contact 111 and the first contact portion 112.

Next, as depicted in FIG. 6B, the plug contact 200 is slightly pulled out of the jack contact 100. As a result, the plug contact 200 is out of contact with the first contact portion 112 while contacting the second contact portion 122 and the third contact portion 132. Accordingly, in the state depicted in FIG. 6B, no electric current flows through the first jack 110.

According to this embodiment, the resistance value of the first resistor 140 is lower than the resistance value of the second resistor 150. Therefore, in the state of FIG. 6B, the electric current flowing from the jack contact 100 to the plug contact 200 flows most through a current path of the lower resistance that goes through the second jack 120. That is, most of the electric current flows from the second jack terminal 123 to the plug contact 200 through the first resistor 140, the second jack contact 121, and the second contact portion 122. Because the electric current continues to flow to the plug contact 200 through the second jack contact 121, no arc is generated at the first contact portion 112 when the first contact portion 112 and the plug contact 200 become out of contact. The electric current that flows from the jack connector to the plug connector in the state depicted in FIG. 6B is limited by the first resistor 140 and is therefore smaller than the electric current that flows when the plug contact 200 and the first contact portion 112 are in contact as depicted in FIG. 6A.

Next, as depicted in FIG. 6C, the plug contact 200 is further pulled out of the jack contact 100. As a result, the plug contact 200 is out of contact with the first contact portion 112 and the second contact portion 122 while contacting the third contact portion 132. As a result, in this state, the electric current flows only through the third jack 130, and no electric current flows through the first jack 110 and the second jack 120.

In the state of FIG. 6C, the electric current flows from the jack contact 100 to the plug contact 200 through the third jack 130 in contact with the plug contact 200. When the second contact portion 122 and the plug contact 200 become out of contact, no arc is generated at the second contact portion 122 because the electric current continues to flow from the third jack terminal 133 to the plug contact 200 through the third jack contact 131. The electric current that flows in the state depicted in FIG. 6C is limited by the second resistor 150 and is therefore smaller than the electric current that flows when the plug contact 200 and the second contact portion 122 are in contact.

Next, as depicted in FIG. 6D, the plug contact 200 is further pulled out of the jack contact 100. As a result, the plug contact 200 is in contact with none of the first contact portion 112, the second contact portion 122, and the third contact portion 132. Accordingly, in the state of FIG. 6D, no electric current flows through the first jack 110, the second jack 120, or the third jack 130.

When the resistance value of the second resistor 150 is 400Ω or more, the electric current that flows from the jack connector to the plug connector is 1 A or less, and the flowing electric current is small. Therefore, no arc is generated between the plug contact 200 and the third contact portion 132 when the plug contact 200 is separated from the third contact portion 132.

Thus, it is possible to prevent the generation of an arc at the time of pulling the plug contact 200 out of the jack contact 100 according to this embodiment.

### Second Embodiment

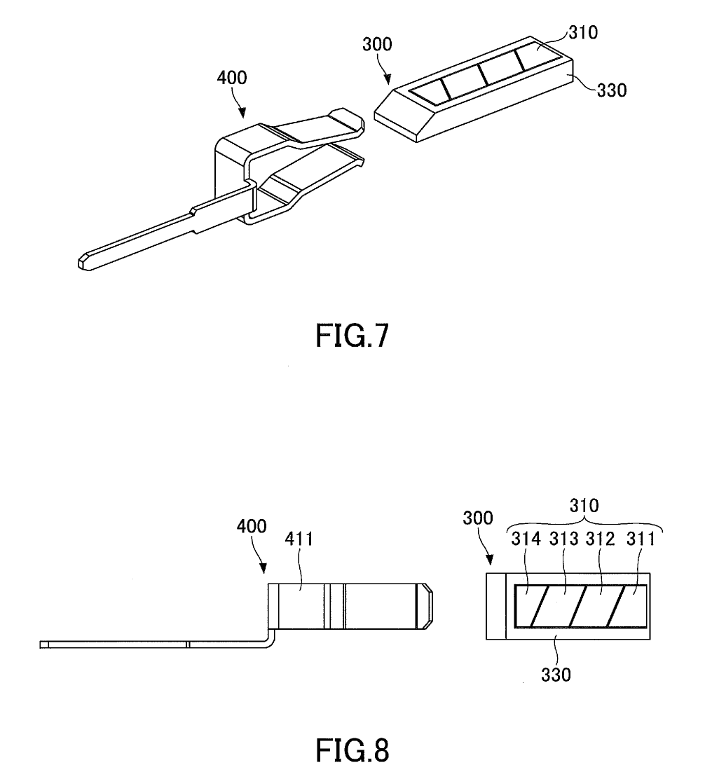

Next, a connector according to a second embodiment is described. FIGS. 7, 8 and 9 are a perspective view, a plan view and a side view, respectively, of a plug contact 300 and a jack contact 400 according to this embodiment. FIG. 10 is an exploded perspective view of the plug contact 300.

The connector according to this embodiment is the plug contact 300 having the structure as depicted in FIGS. 7 through 10 or a plug connector including the plug contact 300. The plug connector may include a housing that is formed of an insulator and exposes the plug contact 300. The plug connector is connected to an electronic apparatus or the like. The connector according to this embodiment mates with and electrically connects to another connector. The other connector may be the jack contact 400 or a jack connector including the jack contact 400. The jack connector may include a housing that is formed of an insulator such as a resin material and surrounds and covers the jack contact 400. An opening is provided in part of the housing where the jack contact 400 fits to the plug contact 300. The jack contact 400 is connected to a power supply cable. According to this embodiment, one of the jack contact 400 and a first metal plate 311 of the plug contact 300 is connected to a power supply and the other is connected to an electronic apparatus or the like.

In the following description, the connector according to this embodiment may be referred to as “plug connector”, and the other connector according to this embodiment may be referred to as “jack connector.”

As depicted in FIG. 10, the plug contact 300 according to this embodiment includes a metal plate 310 divided into segments, a first resistor 321, a second resistor 322, and a third resistor 323.

The metal plate 310 includes the first metal plate 311, a second metal plate 312, a third metal plate 313, and a fourth metal plate 314. The first metal plate 311, the second metal plate 312, the third metal plate 313, and the fourth metal plate 314 are arranged at slight intervals in descending order of a distance from the jack contact 400 to be connected, that is, descending order of a distance to a leading end 300a of the plug contact 300 in a direction in which the plug contact 300 fits into the jack contact 400. The first through fourth metal plates 311 through 314 are formed of a metal material such as copper.

The metal plate 310 is placed in an insulator part 330 formed of an insulator such as a resin material or a ceramic with the first through third resistors 321 through 323 connected to the metal plate 310. The metal plate 310 includes a first surface 310a covered with the insulator part 330 and a second surface 310b exposed on the insulator part 330. Alternatively, the plug contact 300 may be a printed board formed into the shape of a plug contact with elements corresponding to the first through fourth metal plates 311 through 314 formed on a surface, using conductive wires or the like.

As depicted in FIG. 10, according to this embodiment, the first resistor 321 is connected to a surface of the first metal plate 311 and a surface of the second metal plate 312.

Likewise, the second resistor 322 is connected to the surface of the second metal plate 312 and a surface of the adjacent third metal plate 313.

Likewise, the third resistor 323 is connected to the surface of the third metal plate 313 and a surface of the adjacent fourth metal plate 314.

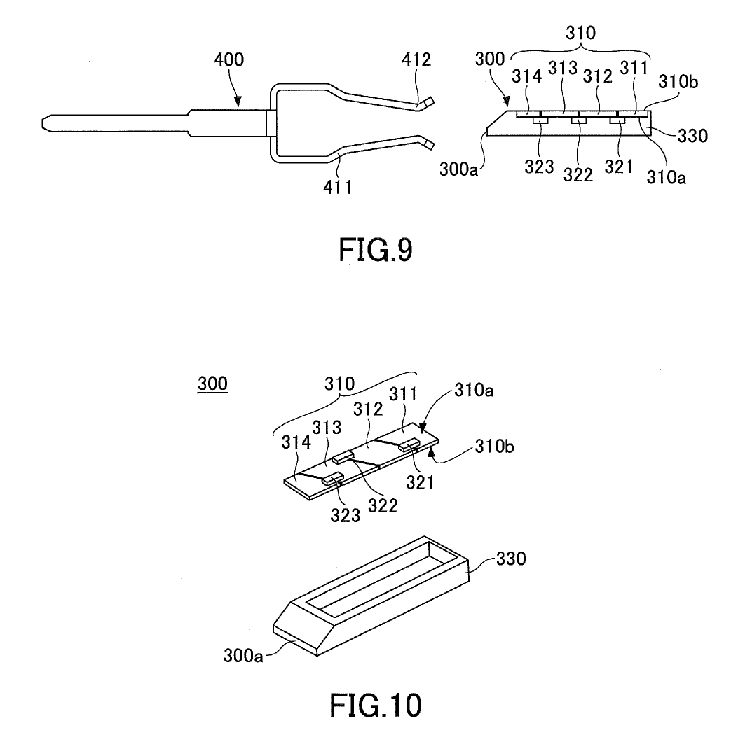

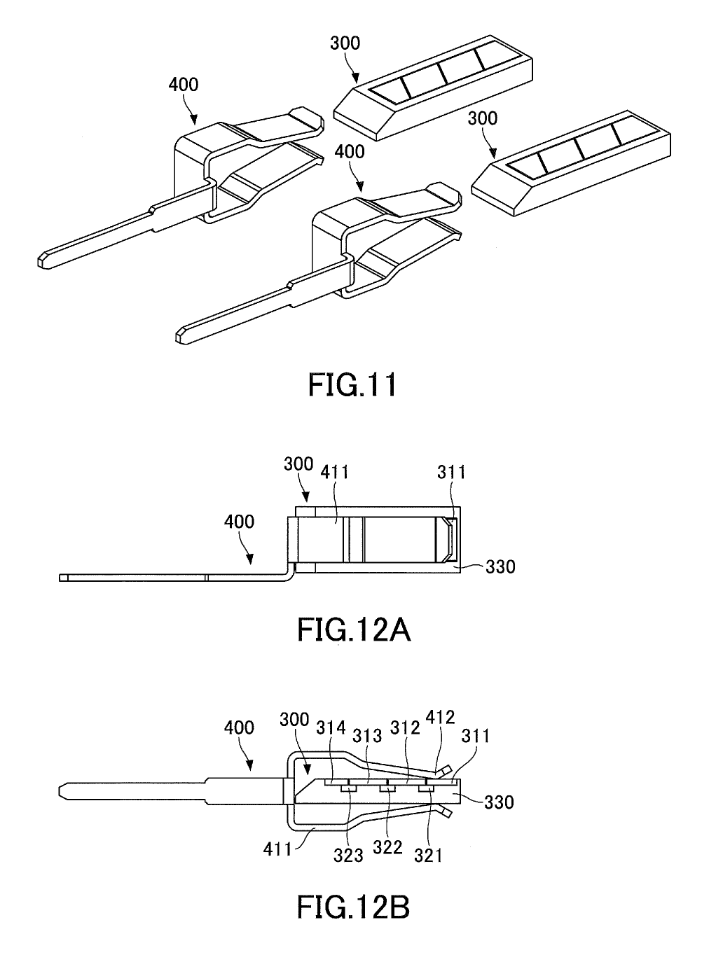

Each of the first through third resistors 321 through 323 is attached to the first surface 310a of the metal plate 310. As depicted in FIG. 9, the metal plate 310 is attached to the insulator part 330 with the first surface 310a to which the first through third resistors 321 through 323 are attached facing inside the insulator part 330. The second surface 310b of the metal plate 310 is substantially in a single plane.

The jack contact 400 is formed of a metal material, and includes a U-shaped jack contact part 411 into which the plug contact 300 is inserted. The jack contact part 411 includes a contact portion 412 that contacts the plug contact 300 in the vicinity of its end.

For example, when the supply voltage is 400 V, no arc is generated if a flowing electric current is 1 A or less. Therefore, according to this embodiment, the resistance value of the series combined resistance of the first through third resistors 321 through 323 is preferably 400Ω or more.

The gap between the first metal plate 311 and the second metal plate 312, the gap between the second metal plate 312 and the third metal plate 313, and the gap between the third metal plate 313 and the fourth metal plate 314 are inclined relative to the fitting direction of the plug contact 300 and the jack contact 400. As a result, when the plug contact 300 is removed from the jack contact 400, the contact portion 412 of the jack contact 400 positioned in the vicinity of the gap between the first metal plate 311 and the second metal plate 312 contacts both the first metal plate 311 and the second metal plate 312.

To be more specific, with the movement of the jack contact 400, the contact portion 412 in contact with the first metal plate 311 alone contacts both the first metal plate 311 and the second metal plate 312, and is thereafter detached from the first metal plate 311 to contact the second metal plate 312 alone. Accordingly, the contact portion 412 is in contact with at least one of the first metal plate 311 and the second metal plate 312. Therefore, it is possible to prevent generation of an arc due to the interruption of a flow of electric current between the jack contact 400 and the plug contact 300.

Likewise, the contact portion 412 contacts both the second metal plate 312 and the third metal plate 313 in the vicinity of the gap between the second metal plate 312 and the third metal plate 313. Furthermore, the contact portion 412 contacts both the third metal plate 313 and the fourth metal plate 314 in the vicinity of the gap between the third metal plate 313 and the fourth metal plate 314. Accordingly, when the plug contact 300 is pulled out of the jack contact 400, the jack contact 400 can be kept in contact with any of the first through fourth metal plates 311 through 314, thus preventing a sudden interruption of electric current. Furthermore, as the metal plate contacted by the jack contact 400 changes from the first metal plate 311 to the second metal plate 312, the third metal plate 313, and the fourth metal plate 314, the resistance value of the plug contact 300 gradually increases to gradually decreases a flow of electric current between the jack contact 400 and the plug contact 300.

According to this embodiment, two plug contacts 300, one positive and one negative, are provided, and likewise, two jack contacts 400, one positive and one negative, are provided.

Next, removal of the plug connector from the jack connector according to this embodiment is described. According to this embodiment, it is assumed that the jack contact 400 is connected to a high-voltage power supply such as a direct-current power supply of +400 V.

FIGS. 12A and 12B are a plan view and a side view, respectively, of the plug contact 300 and the jack contact 400 that are fitted to each other to supply electric power. In the state of FIGS. 12A and 12B, the contact portion 412 of the jack contact 400 is in contact with the first metal plate 311 of the plug contact 300. Therefore, the electric current flows through the first metal plate 311. Accordingly, the electric current flows from the jack contact 400 without going through resistors such as the first resistor 321, the second resistor 322, and the third resistor 323.

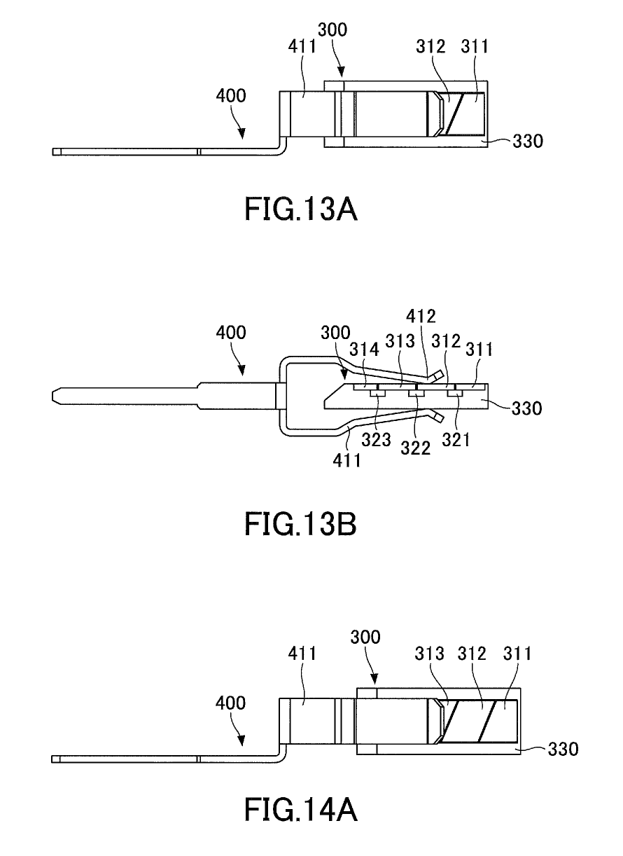

Next, as depicted in FIGS. 13A and 13B, the plug contact 300 is slightly pulled out of the jack contact 400. FIGS. 13A and 13B are a plan view and a side view, respectively, of the jack contact 400 and the plug contact 300 slightly pulled out. By slightly pulling out the plug contact 300, the contact portion 412 of the jack contact 400 contacts the second metal plate 312 of the plug contact 300. When the contact portion 412 is in contact with the second metal plate 312, the electric current flows to the plug contact 300 through the jack contact 400, the second metal plate 312, the first resistor 321, and the first metal plate 311. Accordingly, the electric current is limited by the first resistor 321. Therefore, in the state of FIGS. 13A and 13B, the electric current flowing from the jack contact 400 to the plug contact 300 is smaller than in the state depicted in FIGS. 12A and 12B.

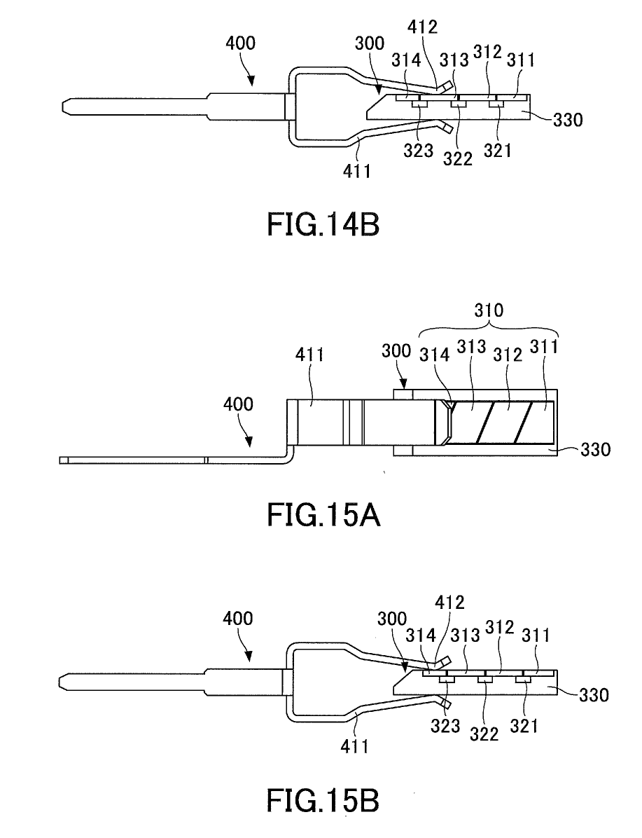

Next, as depicted in FIGS. 14A and 14B, the plug contact 300 is further pulled slightly out of the jack contact 400. FIGS. 14A and 14B are a plan view and a side view, respectively, of the jack contact 400 and the plug contact 300 further pulled out slightly relative to the state depicted in FIGS. 13A and 13B. By further pulling the plug contact 300 slightly out of the jack contact 400, the contact portion 412 contacts the third metal plate 313. When the contact portion 412 is in contact with the third metal plate 313, the electric current flows to the plug contact 300 through the jack contact 400, the third metal plate 313, the second resistor 322, the second metal plate 312, the first resistor 321, and the first metal plate 311. Accordingly, the electric current flowing from the jack contact 400 to the plug contact 300 is limited by the first and second resistors 321 and 322. The combined resistance value of the first and second resistors 321 and 322 is higher than the resistance value of the first resistor 321. Therefore, in the state of FIGS. 14A and 14B, the electric current flowing from the jack contact 400 to the plug contact 300 is smaller than in the state depicted in FIGS. 13A and 13B.

Next, as depicted in FIGS. 15A and 15B, the plug contact 300 is further pulled out of the jack contact 400. FIGS. 15A and 15B are a plan view and a side view, respectively, of the jack contact 400 and the plug contact 300 further pulled out relative to the state depicted in FIGS. 14A and 14B. By further pulling out the plug contact 300, the contact portion 412 contacts the fourth metal plate 314. When the contact portion 412 is in contact with the fourth metal plate 314, the electric current flows to the plug contact 300 through the jack contact 400, the fourth metal plate 314, the third resistor 323, the third metal plate 313, the second resistor 322, the second metal plate 312, the first resistor 321, and the first metal plate 311. Accordingly, the electric current flowing from the jack contact 400 to the plug contact 300 is limited by the first through third resistors 321 through 323. The combined resistance value of the first through third resistors 321 through 323 is higher than the combined resistance value of the first and second resistors 321 and 322. Therefore, in the state of FIGS. 15A and 15B, the electric current flowing from the jack contact 400 to the plug contact 300 is smaller than in the state depicted in FIGS. 14A and 14B.

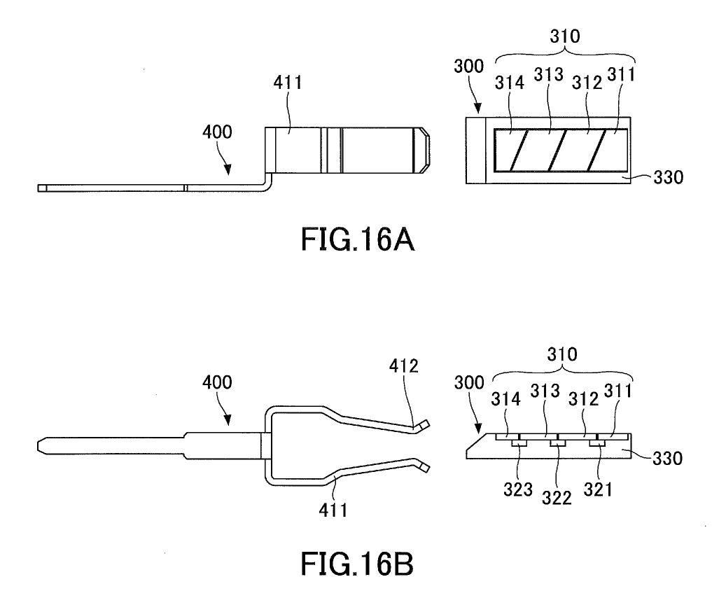

Next, as depicted in FIGS. 16A and 16B, the plug contact 300 is further pulled out of the jack contact 400. FIGS. 16A and 16B are a plan view and a side view, respectively, of the jack contact 400 and the plug contact 300 further pulled out relative to the state depicted in FIGS. 15A and 15B. By further pulling out the plug contact 300, the contact portion 412 comes out of contact with the plug contact 300, so that there is no flow of electric current between the plug contact 300 and the jack contact 400.

When the contact portion 412 of the jack contact 400 is in contact with the fourth metal plate 314 of the plug contact 300, the electric current flows through the third resistor 323, the second resistor 322, and the first resistor 321. When the resistance value of the combined resistance of the first through third resistors 321 through 323 connected in series is 400Ω or more, the flowing electric current is 1 A or less. Because the flowing electric current is small, no arc is generated between the contact portion 412 of the jack contact 400 and the fourth metal plate 314 of the plug contact 300 when the contact portion 412 is detached from the fourth metal plate 314.

Thus, according to embodiments of the present invention, a connector is provided with multiple contacts, and the resistance value of the contacts increases in accordance with the operation of disconnecting the connector and another connector. According to this arrangement, when disconnecting the other connector from the connector, the contact of the other connector contacting a contact of the connector is caused to contact another contact of a high resistance value of the connector, and is thereafter detached from the contact of the connector initially contacted by the other connector. The generation of an arc is prevented by causing the resistance value of a contact of the connector that is last detached from the contact of the other connector to be sufficiently high to limit an electric current flowing through the contacts.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Connectors have been described based on embodiments of the present invention. It should be understood, however, that the various changes, substitutions, and alterations could be made hereto without departing from the spirit and scope of the invention. For example, the form of providing multiple contacts is not limited to providing contacts that are different in resistance value from each other or connecting multiple metal plates with resistors as described above.

### DESCRIPTION OF THE REFERENCE NUMERALS

100 jack contact
110 first jack
111 first jack contact
112 first contact portion
113 first jack terminal
120 second jack
121 second jack contact
122 second contact portion
123 second jack terminal
130 third jack
131 third jack contact
132 third contact portion
133 third jack terminal
140 first resistor
150 second resistor
200 plug contact

1. A connector configured to mate with and electrically connect to another connector, comprising:
a first contact configured to contact said another connector at a first position; and
a second contact having a higher resistance value than the first contact, and configured to contact said another connector at a second position that is closer to a leading end of the connector than is the first position.

2. The connector as claimed in claim 1, wherein, in separating said another connector from the connector, the second contact is detached from said another connector after the first contact is detached from said another connector.

3. The connector as claimed in claim 2, further comprising:
a third contact having a higher resistance value than the second contact, and configured to contact said another connector,
wherein, in separating said another connector from the connector, the third contact is detached from said another connector after the second contact is detached from said another connector.

4. The connector as claimed in claim 1, further comprising:
a resistor connected to the second contact.

5. A connector configured to electrically connect to another connector, comprising:
a first metal plate configured to contact said another connector;
a second metal plate configured to contact said another connector; and
a resistor connected to the first metal plate and the second metal plate.

6. The connector as claimed in claim 5, wherein, in separating said another connector from the connector, the first metal plate is detached from said another connector with the second metal plate contacting said another connector, and the second metal plate is thereafter detached from said another connector.

7. A connector configured to mate with and electrically connect to another connector, comprising:
a contact including a plurality of metal plates configured to contact said another connector; and
a resistor connecting adjacent metal plates among the plurality of metal plates.

8. The connector as claimed in claim 7, wherein, in disconnecting said another connector from the connector, with a metal plate of the adjacent metal plates closer to a leading end of the contact contacting said another connector, a metal plate of the adjacent metal plates more distant from the leading end of the contact is detached from said another connector.

9. The connector as claimed in claim 8, wherein
with said another connector and the connector being in contact, a metal plate at a position most distant from a leading end of the connector in a direction to mate with said another connector among the plurality of metal plates is in contact with said another connector, and
in disconnecting said another connector from the connector, a metal plate at a position next most distant from the leading end of the connector among the plurality of metal plates contacts said another connector with the metal plate at the most distant position contacting said another connector, and the metal plate at the most distant position is detached from said another connector with the metal plate at the next most distant position contacting said another connector.
